(19) United States
(12) Patent Application Publication
(10) Pub. No.: US 2012/0249921 A1
(43) Pub. Date: Oct. 4, 2012

(54) LIGHT GUIDE PLATE, LIQUID CRYSTAL DISPLAY MODULE AND LIQUID CRYSTAL DISPLAY

(75) Inventors: Gang Yu, Shenzhen (CN); Jie Ren, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/258,461

(22) PCT Filed: Jul. 5, 2011
(86) PCT No.: PCT/CN11/76877

§ 371 Date: Sep. 22, 2011

(30) Foreign Application Priority Data
Apr. 2, 2011 (CN) 201120095522.6

(51) Int. Cl. G02F 1/1335; F21V 8/00

(52) U.S. Cl. 349/62; 362/609

(57) ABSTRACT

The patent application claims an L-shaped light guide plate, which consists of a long section and a short section. The long section includes a light emitting surface and an inner side corresponding therewith; one side of the short section that is intersected with the inner side is a light plane of incidence. An LED light bar is positioned at the bottom of the inner side and is arranged on the side of the light plane of incidence. The light emitting surface of the LED light bar is in parallel with the light plane of incidence. Light shoots in from the light plane of incidence and is then reflected to the light emitting surface of the long section by a reflecting plate. The patent application further provides a liquid crystal display module and a liquid crystal display, which are provided with said light guide plates. In the light guide plate, the liquid crystal display module or the liquid crystal display provided by this patent application, the light guide plate is arranged in segmentation and the LED light bar is arranged below the light guide plate; so that the internal space of the machine body can be saved, and the design of the narrow frame of the machine body can be realized.

### FIELD OF THE PATENT APPLICATION

The patent application relates to a light guide plate, a liquid crystal display module and a liquid crystal display; in particular to a light guide plate, a liquid crystal display module and a liquid crystal display capable of realizing the design of narrow frame, which belong to the field of liquid crystal technology.

### BACKGROUND

As well known in the field of liquid crystal display, LED (Light Emitting Diode) light source is the one capable of controlling and performing the area brightness to the best effect among the existing backlight source. Since the side-light LED backlight module has the advantages such as cost, the development direction of the liquid crystal technology is generally favored by the industry.

FIG. 1 shows the framework of the most side-light LED backlight modules of existing technology, including a light bar 110 and a light guide plate 200. The light bar 110 and the light guide plate 200 are placed in parallel. With the development of technology, the lighting efficiency of the LED is being improved constantly, and the brightness of a single LED is also increased. As a result, the quantity of LED reduces when the side-light LED backlight module is in actual use so that the cost is effectively reduced, however, obvious hotspots occur by doing so. In order to alleviate such phenomenon, the quantity of LED or the light mixing distance must be increased. Thus, the frame width of the whole module will be increased and the machine body cannot realize the design of narrow frame.

### SUMMARY

The main purpose of the patent application is to provide a light guide plate, a liquid crystal display module and a liquid crystal display; it aims at effectively solving the problem of the frame increasing due to the increasing of the light mixing distance and realizing the design of the narrow frame.

In order to realize the above purposes, the patent application provides a light guide plate. The light guide plate is L-shaped and includes a long section and a short section. The long section includes a light emitting surface and an inner side corresponding therewith. One side of said short section that is intersected with the inner side is a light plane of incidence. The LED light bar is positioned at the bottom of the inner side and is arranged on the side of the light plane of incidence. The light emitting surface of the LED light bar is in parallel with the light plane of incidence. Light shoots in from the light plane of incidence and is then reflected to the light emitting surface of the long section by a reflecting plate.

Preferably, the long section is adhered to the short section.

Preferably, the long section and the short section are integrally arranged.

Preferably, the inner side of the long section is provided with a reflecting piece.

Preferably, the light emitting surface of the long section is provided with a plurality of grooves. Net points are provided around the grooves.

Preferably, the grooves are arranged in a V shape, an arc shape or a rectangle shape.

Preferably, the reflecting surface of the light guide plate is oblique.

The patent application provides a liquid display module, including a light guide plate, a reflecting plate and an LED light bar, wherein the light guide plate that is shaped like a letter L includes a long section and a short section; the long section includes a light emitting surface and an inner side corresponding therewith; one side formed by intersecting the short section with the inner side is a light plane of incidence; the LED light bar is positioned at the bottom of the inner side and is arranged on the side of the light plane of incidence; the light emitting surface of the LED light bar is in parallel with the light plane of incidence; light shoots in from the light plane of incidence and is then reflected to the light emitting surface of the long section by the reflecting plate.

Preferably, the reflecting plate is arranged in arc shape.

The patent application provides a liquid crystal display, including a liquid crystal display module; the liquid crystal display module includes a light guide plate, a reflecting plate and an LED light bar; wherein the light guide plate is L-shaped and includes a long section and a short section; the long section includes a light emitting surface and an inner side corresponding therewith; one side of the short section that is intersected with the inner side is a light plane of incidence; the LED light bar is positioned at the bottom of the inner side and is arranged on one side of the light plane of incidence; the light emitting surface of the LED light bar is in parallel with the light plane of incidence; light shoots in from the light plane of incidence and is then reflected to the light emitting surface of the long section by a reflecting plate; the long section and the short section of the light guide plate are integrally arranged or adhered mutually.

The patent application provides a light guide plate, a liquid crystal display module or a liquid crystal display. The light guide plate is arranged in segmentation; light emitted from the LED light bar shoots in from the short section of the light guide plate and is then reflected to the light emitting surface of the long section by a reflecting plate. Therefore, the patent application can effectively solve the problem of the frame increasing due to the increasing of the light mixing distance and realizing the design of the narrow frame; so as to save the raw materials used for the front frame and the rubber frame and make the outer appearance of the whole machine designed simpler.

### DESCRIPTION OF THE DRAWINGS

FIG. 1 is a schematic diagram showing the structure of the light guide plate and the LED light bar in existing technology.

FIG. 2 is a schematic diagram showing the structure of a preferable embodiment of the liquid crystal display module according to the patent application.

FIG. 3 is a schematic diagram showing the structure of a preferable embodiment of the light guide plate according to the patent application.

FIG. 4 is a schematic diagram showing the connecting structure of a preferable embodiment of the light guide plate according to the patent application.

FIG. 5 is a schematic diagram showing the structure of a preferable embodiment of the reflecting plate according to the patent application.

FIG. 6 is a schematic diagram showing the structure of a preferable embodiment of the reflecting plate according to the patent application.

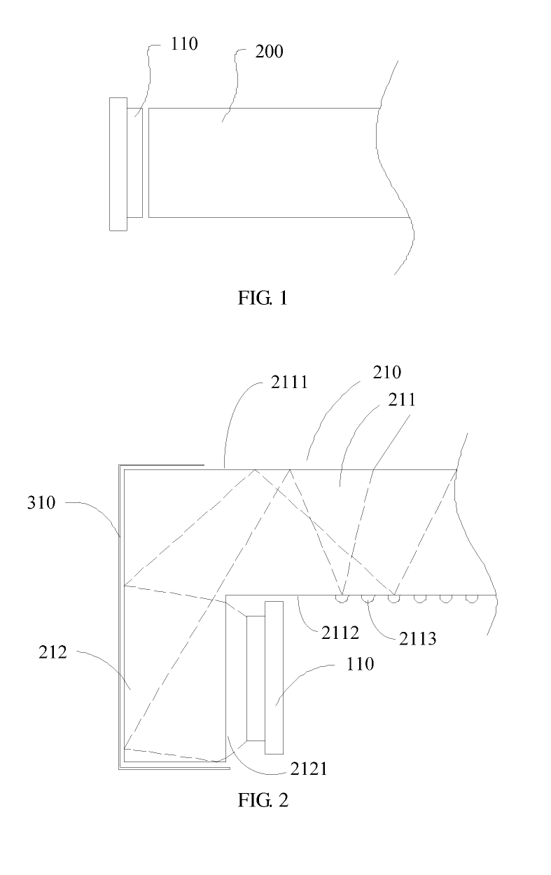

The purpose implementation, the function features and advantages of the patent application will be further illustrated by integrating the exemplary embodiments and taking the attached drawings as references.

### DETAILED DESCRIPTION

The general thought of the patent application is to fold angles for the light guide plate and arrange the LED light bar below the long section, so as to save the internal space of the machine body and realize the design of the narrow frame. The technical method for realizing the purpose of the patent application will be exactly illustrated according to the attached drawings and the exemplary embodiments. It should be understood that the described detailed exemplary embodiment is only used for illustrating this patent application rather than limiting.

The patent application provides a liquid crystal display module, and referring to FIG. 2, such liquid crystal display module includes a light guide plate 210, a reflecting plate 310 and an LED light bar 110, wherein the light guide plate 210 is L-shaped and includes a long section 211 and a short section 212. The long section 211 includes a light emitting surface 2111 and an inner side 2112 corresponding therewith. One side of the short section 212 that is intersected with the inner side 2112 is a light plane of incidence 2121. The LED light bar 110 is positioned at the bottom of the inner side 2112 and is arranged on the side of said light plane of incidence 2121. The light emitting surface of the LED light bar is in parallel with the light plane of incidence 2121. Light shoots in from the light plane of incidence 2121 and is then reflected to the light emitting surface of the long section 211 by a reflecting plate 310.

The liquid crystal display module of the patent application can be applied to the liquid crystal display. Besides the light guide plate 210, the reflecting plate 310 and the LED light bar 110, the liquid crystal display includes a front frame, a back frame (not shown in the FIGS), etc. The front frame is connected to the periphery of the liquid crystal module. Relative to the user, the light guide plate 210 is arranged into the front frame. Since the light guide plate 210 is arranged in an L shape, the front frame can save the width of the short section 212; or it can cover the whole module. The edge width of the front frame can be saved to realize the design of the narrow frame. The outer appearance of the whole machine of the liquid crystal display becomes simpler and the display area becomes relatively larger.

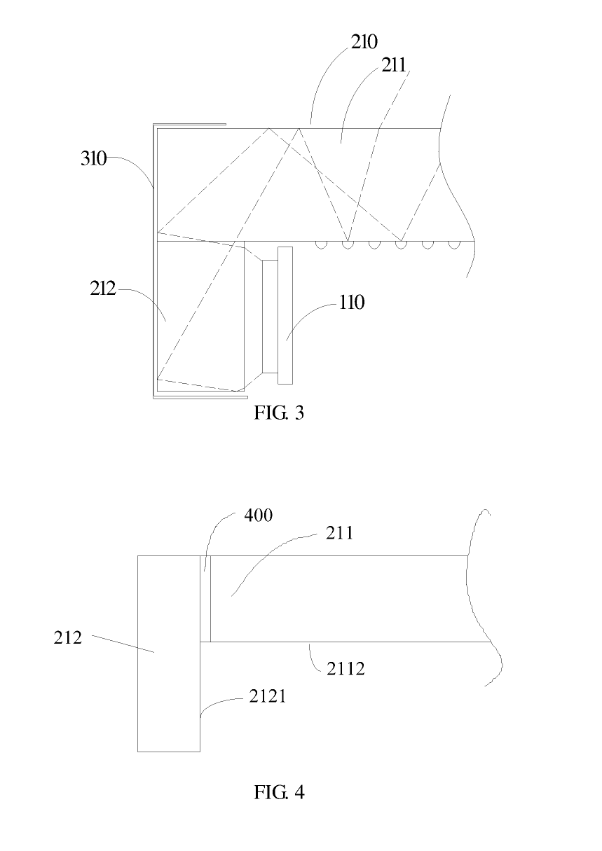

The connecting methods between the long section 211 and the short section 212 of the light guide plate 210 are diversified, which can be flexibly selected. In an embodiment, the long section 211 and the short section 212 are integrally arranged, for example, an integrally-arranged light guide plate 210 can be obtained by the method of mould shaping. Referring to FIG. 3, in an embodiment, the long section 211 and the short section 212 of the light guide plate 210 are arranged in segmentation and are connected together via the UV adhesive or via the available feasible connecting methods such as buckling or splicing. In a specific embodiment, a buckling structure can be arranged on the short section 212 and the long section 211, for example, a buckle tenon is arranged on the long section 211 or the short section 212, and a buckle groove fitted with the buckle tenon is arranged on the other section; the buckle tenon and the buckle groove are fitted to connect the long section 211 with the short section 212 together. In another specific embodiment, a plug component which has the same material with the light guide plate 210 is further arranged; the two ends of the plug component are both provided with plug hooks, which are plugged into the long section 211 and the short section 212 respectively so as to connect the two sections together.

Referring to FIG. 4, which shows another connecting form of the long segmental section 211 and the short segmental section 212. The differences among this embodiment and the foregoing embodiments are as follows: on the short section 212, the upper part of the light plane of incidence 2121 is connected with the long section 211, which are connected together via the UV adhesive 400 or via the available feasible connecting components.

In an embodiment, the reflecting pieces can be adhered to the inner side 2112 and the LED light bar 110 to prevent light directly penetrating the long section 211 and causing the local light leak.

Additionally, in order to guide light equally, grooves can be arranged on the light emitting surface 2111. A plurality of net points are arranged on the grooves so that the ray from the point light source can be scattered through the grooves and the net points. In an embodiment, the grooves can be arranged in a V shape, an arc shape or a rectangle shape.

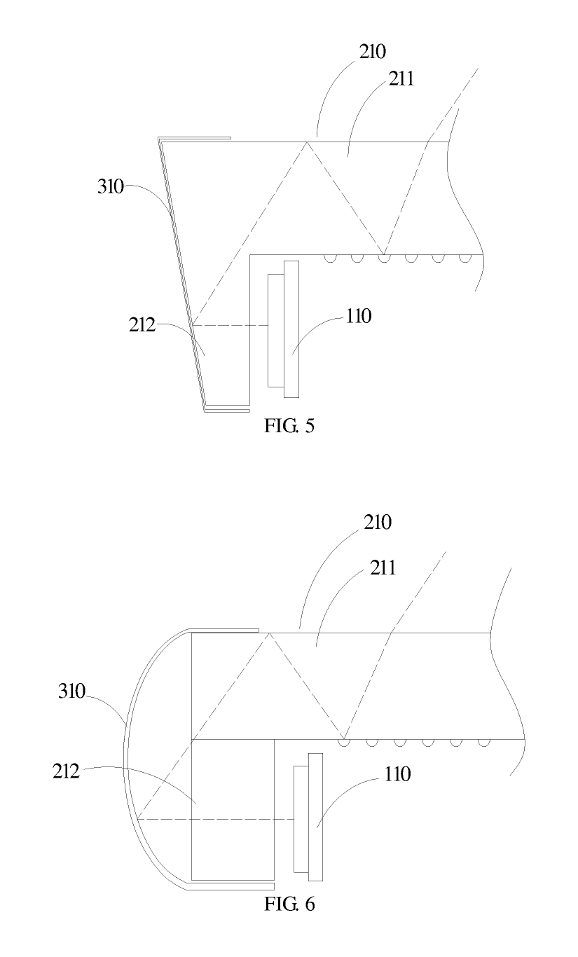

In above embodiments, the shape of the reflecting plate 310 and the shape of the reflecting surface of the light guide plate 210 have multiple choices. Please refer to FIG. 5, in an embodiment, the reflecting surface of the light guide plate 210 is an oblique surface. Please refer to FIG. 6 in another embodiment, the reflecting plate 310 is arranged in an arc shape.

As is well known by the technicians in this field, the liquid crystal display module further includes a backboard which can be formed into a back frame positioned on the outside of the reflecting plate 310. In the embodiment of the patent application, the LED light bar 110 can also be directly contacted with the backboard in order to provide a heating dissipation channel for reducing the influence towards the component property by the heat.

The patent application further provides a liquid crystal display, which includes the liquid crystal display module. The liquid crystal display module is provided with the light guide plate 210, the reflecting plate 310 and the LED light bar 110. In the embodiment of liquid crystal display according to the patent application, since the light guide plate 210 is arranged in an L shape, the front frame can save the width of the short section 212 at least; it also can cover the whole module, to realize the design of the narrow frame by saving the edge width of the front frame. The outer appearance of the whole machine of the liquid crystal display becomes simpler and the display area becomes relatively larger. In the embodiment of the liquid crystal display of the patent application, the liquid crystal module includes all the schemes of the light guide plates shown in FIG. 2 to FIG. 6. The above embodiments can be taken as references, details would not be illustrated.

What is illustrated above is just a preferable embodiment, which will not limit the patent scope of the patent application. Any equivalent replacements made by the specifications and drawings of the patent application, which are directly or indirectly applied to other technical fields, should be included into the protection scope of the patent application.

What is claimed is:

1. A light guide plate, wherein the light guide plate is L-shaped and comprises a long section and a short section; the long section comprises a light emitting surface and an inner side corresponding therewith; one side of the short section that is intersected with the inner side is a light plane of incidence; the LED light bar is positioned at the bottom of the inner side and is arranged on the side of the light plane of incidence; the light emitting surface of the LED light bar is in parallel with the light plane of incidence; light shoots in from the light plane of incidence and is then reflected to the light emitting surface of the long section by a reflecting plate.

2. The light guide plate according to claim 1, wherein the long section is adhered to the short section.

3. The light guide plate according to claim 1, wherein the long section and the short section are integrally arranged.

4. The light guide plate according to claim 3, wherein the inner side of the long section is provided with a reflecting piece.

5. The light guide plate according to claim 4, wherein the light emitting surface of the long section is provided with a plurality of grooves; net points are provided around the grooves.

6. The light guide plate according to claim 5, wherein said grooves are arranged in a V shape, an arc shape or a rectangle shape.

7. The light guide plate according to claim 6, wherein the reflecting surface of the light guide plate is an oblique plane.

8. A liquid crystal display module, comprising a light guide plate, a reflecting plate and an LED light bar, wherein the light guide plate is L-shaped and comprises a long section and a short section; the long section comprises a light emitting surface and an inner side corresponding therewith; one side of the short section that is intersected with the inner side is a light plane of incidence; the LED light bar is positioned at the bottom of the inner side and is arranged on the side of the light plane of incidence; the light emitting surface of the LED light bar is in parallel with the light plane of incidence; light shoots in from the light plane of incidence and is then reflected to the light emitting surface of the long section by a reflecting plate.

9. The liquid crystal display module according to claim 8, wherein the reflecting plate is arranged in arc shape.

10. The liquid crystal display module according to claim 9, wherein the long section and the short section of the light guide plate are adhered together.

11. The liquid crystal display module according to claim 8, wherein the long section and the short section of the light guide plate are integrally arranged.

12. The liquid crystal display module according to claim 11, wherein the inner side of the long section of the light guide plate is provided with a reflecting piece.

13. The liquid crystal display module according to claim 12, wherein the light emitting surface of the long section is provided with a plurality of grooves; and net points are provided around the grooves.

14. The liquid crystal display module according to claim 13, wherein the grooves are arranged in a V shape, an arc shape or a rectangle shape.

15. The liquid crystal display module according to claim 14, wherein the reflecting surface of the light guide plate is an oblique plane.

16. A liquid crystal display, comprising a liquid crystal display module; the liquid crystal display module comprises a light guide plate, a reflecting plate and an LED light bar; wherein the light guide plate is L-shaped and comprises a long section and a short section; the long section comprises a light emitting surface and an inner side corresponding therewith; one side of the short section that is intersected with the inner side is a light plane of incidence; the LED light bar is positioned at the bottom of the inner side and is arranged on the side of the light plane of incidence; the light emitting surface of the LED light bar is in parallel with the light plane of incidence; light shoots in from the light plane of incidence and is then reflected to the light emitting surface of the long section by a reflecting plate; the long section and the short section of the light guide plate are integrally arranged or adhered mutually.

17. The liquid crystal display according to claim 16, wherein the inner side of the long section of the light guide plate is provided with a reflecting piece.

18. The liquid crystal display according to claim 17, wherein the light emitting surface of the long section is provided with a plurality of grooves; and the peripheries of the grooves are provided with net points.

19. The liquid crystal display according to claim 18, wherein the grooves are arranged in a V shape, an arc shape or a rectangle shape.

20. The liquid crystal display according to claim 19, wherein the reflecting surface of the light guide plate is an oblique plane.
